(19) United States
(12) Patent Application Publication
(10) Pub. No.: US 2026/0320545 A1
(43) Pub. Date: Oct. 15, 2026

(54) AUTONOMOUS PROCUREMENT ASSISTANT SYSTEM USING AGENTIC ORCHESTRATION AND PROCUREMENT METHOD THEREOF

(71) Applicant: Zycus Infotech Pvt Ltd, Mumbai (IN)

(72) Inventors: Shekhar Verma, Mumbai (IN); Tejit Mithal, Mumbai (IN); Shabeesh Balan, Mumbai (IN); Sneha Adhav, Mumbai (IN); Pridhvi Kare, Mumbai (IN); Soham Niyogi, Mumbai (IN)

(21) Appl. No.: 19/632,345

(22) Filed: Mar. 29, 2026

(30) Foreign Application Priority Data
Mar. 29, 2025 (IN) 202521030608

(51) Int. Cl. G06Q 10/087

(52) U.S. Cl. CPC G06Q 10/087

(57) ABSTRACT

An autonomous procurement assistant system using agentic orchestration and procurement method thereof; comprising a user an input or output unit including a computer-based application, a collaboration dialogue window, a processing unit with a natural language processing engine (NLP), policy mapping unit and an agentic orchestration engine displaying an agentic workflow, validating deviations from policies, finally providing a plurality of procurement agents from catalog selection agent, supplier selection agent, sourcing agent, negotiation agent, contract creation agent and contract signing agent based on the user input; thereby employing an agentic orchestration workflow run by the orchestration engine; such that the agentic orchestration using various agents that automate the procurement tasks while ensuring policy compliances; allowing users to customize and configure the procurement workflows within the policy constraints; providing real-time alerts and checks timelines thereby preventing inefficiencies, and adaptive intelligent learning from previous procurement workflows in return improving procurement efficiency over time.

### CROSS-REFERENCE TO RELATED APPLICATION

The instant application claims priority to Indian Patent Application Serial No. 202521030608, filed Mar. 29, 2025, the entire specification of which is expressly incorporated herein by reference.

### FIELD OF THE INVENTION

The present invention generally relates to a procurement system. More particularly, it relates to an autonomous procurement assistant system using agentic orchestration and procurement method thereof; providing a single collaboration dialogue window integrated with the computer-based applications to centralize and automate the procurement workflows thereby ensuring compliance with procurement policies while optimizing efficiency.

### BACKGROUND OF THE INVENTION

A procurement application is a business application designed to streamline and automate procurement processes for entities, encompassing activities from sourcing to payment, and aiming to improve efficiency and reduce costs. Procurement applications generally manage the entire procurement lifecycle, including identifying and selecting suppliers, creating purchase orders, managing requisitions, and executing orders. These procurement applications also track inventory levels, ensure timely replenishments, manage supplier contracts and ensure compliance with policies. Further, they manage invoices by processing and paying invoices, and analyze spending patterns to identify areas for cost savings.

The available procurement systems have certain limitations such as lacking ease of use and autonomous execution of procurement events as there is no centralized system for all steps within the procurement process. The traditional systems also lack effective measures to avoid the risk of deviating from procurement policies and other manual errors in compliance as each step requires manual intervention to initiate the next step where the user is required to manually log into multiple disparate systems to perform procurement activities. Further, for using any procurement related systems, different transactions are required to be done such as logging into the procurement system to select catalogues and raise requisitions, and separately logging into the sourcing system to select suppliers. To check the reliability of a supplier, the user has to then access a risk management system. Finally, the user has to log into the contract management system to complete the process. The user is thus required to continuously hop between different systems for each step in the procurement process, which makes the procurement process cumbersome and inefficient.

IN202521007133 discloses an intelligent decision-making framework for strategic sourcing, leveraging AI-powered procurement models to optimize supplier evaluation, mitigate risks, and enhance cost efficiency while aligning with sustainability goals. The framework integrates a data aggregation module, AI analytics, and a decision support system to process real-time data from diverse sources, enabling dynamic and adaptive sourcing strategies.

IN202521007131 relates to an AI-based predictive analytics system designed to optimize procurement and strategic sourcing in utility sectors such as energy, water, and gas. A data integration module aggregates structured and unstructured data from multiple sources, while a demand forecasting engine predicts consumption trends using historical and real-time inputs.

U.S. Pat. No. 10,524,268 discloses an intelligent resource procurement system. The system typically includes a processor, a memory, and a resource management module stored in the memory. The system identifies a resource deficiency, establishes a secure communication channel with a portable electronic device, and transmits instructions causing the portable electronic device to display resource procurement information related to the resource deficiency.

All the prior arts hereinabove disclose the procurement systems with primary emphasis on strategic sourcing which is an advanced subset of procurement, focusing on optimizing supplier relationships. However, they fail to provide a system which will provide assistance to the user to promote ease of use, decrease inefficiencies and delays in procurement processes, and mitigate risks due to manual errors or policy deviations. Also, none of the prior arts disclose robust end-to-end assistance to the user for procurement of items by integrating all procurement steps. To overcome the drawbacks of the available procurement systems, it is necessary to provide an alternative system and method which will provide automated assistance to the user in procurement workflows to tackle inefficiencies, delays and manual errors.

### OBJECTS OF THE INVENTION

The primary object of the present invention is to provide an autonomous procurement assistant system using agentic orchestration and procurement method thereof.

Another object of the present invention is to provide a centralized system for procurement workflows.

Yet another object of the invention is to provide an automated procurement system to eliminate manual intervention through agent orchestration by utilizing inputs from preceding agents.

Yet another object of the invention is to ensure risk management and compliance with procurement policies.

Yet another object of the invention is to learn from previous transactions and improve procurement efficiency from regular use over a period of time.

### SUMMARY OF THE INVENTION

Before the present invention is described, it is to be understood that the present invention is not limited to specific methodologies and materials described, as these may vary as per the person skilled in the art. It is also to be understood that the terminology used in the description is for the purpose of describing the particular embodiments only and is not intended to limit the scope of the present invention.

The present invention discloses an autonomous procurement assistant system using agentic orchestration and procurement method thereof, providing a single collaboration dialogue window integrated with the computer-based applications to centralize and automate the procurement workflows thereby ensuring compliance with procurement policies while optimizing efficiency. The system comprises of a user, an input or output unit including a computer-based application with a collaboration dialogue window, a processing unit with a natural language processing engine, policy mapping unit and an agentic orchestration engine displaying an agentic workflow, validating deviations from policies, finally providing an agentic orchestration workflow run by the orchestration engine.

In one aspect, the method employed by the processing unit includes user interaction through computer-based application, policy mapping and agentic orchestration, agentic orchestration execution, intelligent recommendations and adaptive learning from previous procurement workflows in return improving procurement efficiency over time, and providing real-time status updates on dialogue window of computer-based application; thereby allowing the sequential steps for procuring the user request through a collaborative interaction between the user and the system using the dialogue window thereby allowing the users to track procurement progress without logging into different disparate systems thereby preventing inefficiencies in procurement workflows.

In another aspect, agentic orchestration workflow enables the catalog selection agent to retrieve and filter catalogues based on the user requirements, the supplier selection agent to identify the suppliers by adhering to pre-defined preferences, the sourcing agent to send requests to the shortlisted suppliers, collect and consolidate the supplier bids, the negotiation agent to analyse bid data, negotiating the optimal pricing and terms by engaging in autonomous communication with suppliers, the contract creation agent to auto-generate the procurement contracts by incorporating negotiated terms and compliance requirements and contract signing agent to approve contract thereby ensuring compliance with e-signature and legal validation.

### BRIEF DESCRIPTION OF THE DRAWINGS

The present invention, together with further objects and advantages thereof, is more particularly described in conjunction with the accompanying drawings in which:

FIG. 1 illustrates a schematic view of the system and the various components incorporated in the system of the present invention.

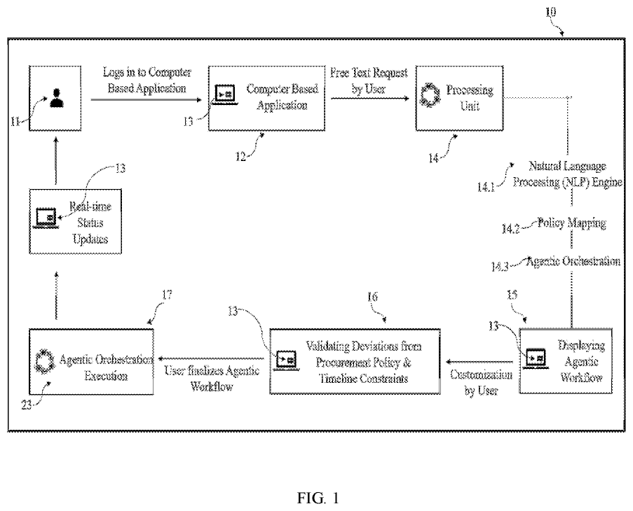

FIG. 2 illustrates a schematic view of the stepwise procurement method employed by processing unit of the autonomous procurement assistant system.

FIG. 3 illustrates a schematic view of the components and workflow of the agentic orchestration execution performed by the processing unit of the system.

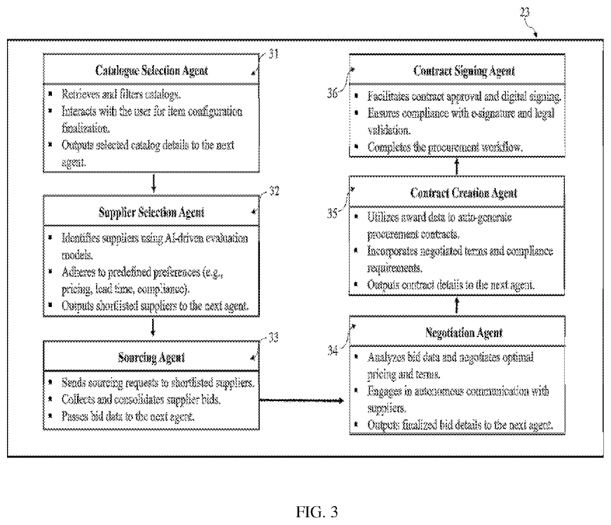

### DETAILED DESCRIPTION OF THE INVENTION

Before the present invention is described, it is to be understood that this invention is not limited to methodologies described, as these may vary as per the person skilled in the art. It is also to be understood that the terminology used in the description is for the purpose of describing the particular embodiments only and is not intended to limit the scope of the present invention. Throughout this specification, the word “comprise”, or variations such as “comprises” or “comprising”, will be understood to imply the inclusion of a stated element, integer or step, or group of elements, integers or steps, but not the exclusion of any other element, integer or step, or group of elements, integers or steps. The use of the expression “at least” or “at least one” suggests the use of one or more elements or ingredients or quantities, as the use may be in the embodiment of the invention to achieve one or more of the desired objects or results. Various embodiments of the present invention are described below. It is, however, noted that the present invention is not limited to these embodiments, but rather the intention is that modifications that are apparent are also included.

The present invention discloses an autonomous procurement assistant system using agentic orchestration and procurement method thereof; providing a single collaboration dialogue window integrated with the computer-based applications to centralize and automate the procurement workflows thereby ensuring compliance with procurement policies while optimizing efficiency. The autonomous procurement assistant system (10) comprises of a user (11) and input or output unit (12) including a computer-based application with a collaboration dialogue window (13), a processing unit (14) with a natural language processing engine (NLP) (14.1), policy mapping unit (14.2) and an agentic orchestration engine (14.3) displaying an agentic workflow (15), followed by validating deviations from policies (16), finally providing a plurality of procurement agents (17) based on the user input or query comprising, but not limited to catalog selection agent (31), supplier selection agent (32), sourcing agent (33), negotiation agent (34), contract creation agent (35) and contract signing agent (36) sequentially interact to provide an agentic orchestration workflow (23) run by the orchestration engine (14.3); whereby the processing unit (14) employs a stepwise method (20) for procurement with including the workflow (23) for agentic orchestration execution. The system (10) works due to interaction of plurality of structural components such as user interfaces, input/output devices or units (12), dialogue window (13), processing unit (14), NLP engine (14.1); along with the functional components included in the workflow along with human interaction at various stages of the procurement process.

According to an embodiment of the invention, the autonomous procurement assistant system (10) allows the user (11) to initiate the procurement workflow (20) by adding a free-text input using the dialogue interface within the computer-based application (12); followed by interpreting the request/s and identifying the key parameters relevant to the input, by the natural language processing engine of the processing unit (14). Once the request is confirmed, the system (10) identifies procurement policies (16), generates agentic orchestration, display, customize and validate agentic workflows (15) to autonomously complete the validated workflow (23) for procurement of the requested item; thereby completing a procurement workflow (23) seamlessly.

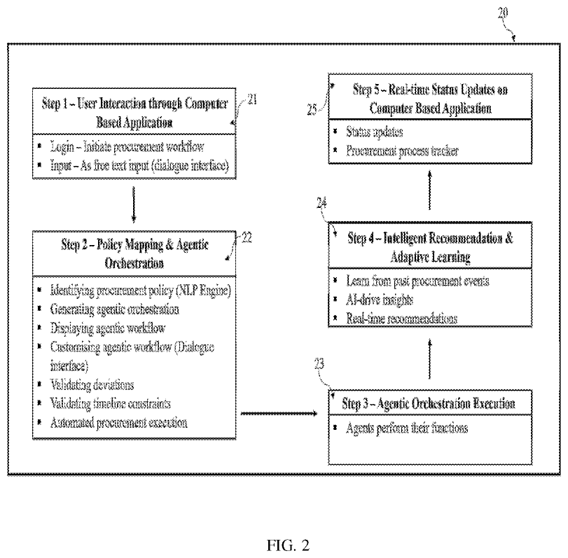

In a preferred embodiment of the present invention, the autonomous procurement assistant system (10) employs a method for procurement (20) as illustrated in FIG. 2. comprising the steps as follows:

### 1. User Interaction Through Computer-Based Application (21)

The user (11) logs into the procurement assistant system (10) integrated within a computer-based application (12) (e.g. Teams, Google meet, Zoom); whereby the system (10) allows the user (11) to initiate the procurement actions directly within the said application (12) thereby avoiding the need to access multiple separate procurement platforms for different procurement requisitions;

Once the user (11) logs into the system (10), the user (11) types the procurement requisition in the form of “a free text” in the dialogue window (13), which is an input for the procurement system (10);

On receiving the input as a free-text, the natural language processing (NLP) engine (14.1) interprets the request provided by the user (11) and identifies the relevant parameters such as
a. item type including but not limited to laptops, office chairs, software license;
b. quantity i.e. number of items to be procured (5,10, 50);
c. department including, but not limited to finance, human resource (HR), information technology (IT) and like; or
d. any additional constraints including, but not limited to budget limits, policy mandates, supplier restrictions and so on;

The system (10) then sends a confirmation message of the requisition in the dialogue window (13) where the user (11) either selects the option “confirm” to proceed with the procurement; or the option “refine details before proceeding” to modify the requisition details.

### 2. Policy Mapping and Agentic Orchestration (22)

Once the user (11) confirms the procurement request, the system (10) automatically maps the user's request against the company's pre-defined procurement policies (16) using the policy mapping unit (14.2).

The system (10) then generates an agentic orchestration; whereby the system (10) selects the necessary agents form an agentic library to create an automated workflow (15) such that the agentic orchestration includes a structured sequence where each agent follows an optimal sequence dynamically determined by the system (10) thereby performing a dedicated role to complete the procurement process efficiently.

The agentic workflow (15) is then visually displayed on collaboration dialogue window (13) outlining the proposed procurement steps and the estimated timeline for procurement completion.

The next step includes customizing configuration changes in the agentic workflow (15) wherein the user (11) may include additional agents based on any specific actions required to complete the process; in addition to the mandatory agents required as per procurement policy.

The system (10) validates the deviations of the configuration changes from the procurement policies (16) of the company; where the system (10) does not allow the mandatory agents to be removed at customization step.

Once the user (11) finalizes the agentic workflow (15) wherein the orchestration engine (14.3) of the processing automates the procurement process by triggering the event such that each agent from a plurality of procurement agents (17) executes an independent task utilizing the inputs from the preceding agents ensuring smooth transitions and minimal manual intervention.

### 3. Agentic Orchestration Execution (23):

The agentic orchestration engine (14.3) provides an agentic orchestration workflow (23) with a sequential step-by-step interaction of various procurement agents (17) including, but not limited to a catalog selection agent (31), supplier selection agent (32), sourcing agent (33), negotiation agent (34), contract creation agent (35) and contract signing agent (36) as final step completing the workflow (23) based on the user input or procurement query raised by the user (11).

### 4. Intelligent Recommendations and Adaptive Learning (24)

The system (10) learns from past procurement events to refine future workflows such that the system (10) provides real-time recommendations for agent additions, removals, or sequence adjustments based on procurement trends and historical success rates thereby guiding the users (11) through generative AI driven insights in optimizing the procurement processes.

### 5. Real-time Status Updates on Dialogue Window of Computer-Based Application (25)

The system (10) provides status updates on the dialogue window (13) as each agent completes its task allowing the users (11) to track procurement progress without logging into different disparate systems.

In a next preferred embodiment of the present invention, the agentic orchestration workflow (23) performed by the agentic orchestration engine (14.3) of the processing unit (14) is disclosed. The stepwise workflow (23) includes the various procurement agents (17) performing the steps as follows:
i. the catalog selection agent (31) retrieves and filters catalogues based on the user (11) requirements, interacts with the user (11) to finalize the workflow configuration and provides the catalogue details as output to the supplier selection agent (32);
ii. the supplier selection agent (32) identifies the suppliers using AI-driven evaluation models where it adheres to pre-defined preferences thereby providing a list of shortlisted suppliers as output for the sourcing agent (33):
   iii. the sourcing agent (33) sends sourcing requests to the shortlisted suppliers, collects and consolidates the supplier bids finally passing the bid data to the negotiation agent (34);
iv. the negotiation agent (34) analyses the bid data and negotiates the optimal pricing and terms by engaging in autonomous communication with the suppliers thereby sending the finalized bid details to the contract creation agent (35);
v. the contract creation agent (35) award data to auto-generate the procurement contracts by incorporating negotiated terms and compliance requirements further sending the contract details and documents to the contract signing agent (36);
vi. the contract signing agent (36) facilitates contract approval and digital signing thereby ensuring compliance with e-signature and legal validation finally completing the procurement workflow (23) where the approved document is presented to the user (11) through the dialogue window (13).

### Advantages

The assistant system (10) of present invention provides significant advantages as the system (10) provides a dialogue window (13) within a computer-based application (12) allowing the users (11) to interact with the system (10) entirely without switching between multiple applications (12); allowing free text input allows conversing with the system (10) to provide a tangible output; agentic orchestration using AI driven agents automate the procurement tasks while ensuring policy compliances; allows users (11) to customize and configure the procurement workflows within the policy constraints (16); provides real-time alerts and checks timelines thereby preventing inefficiencies, and adaptive intelligent learning from previous procurement workflows in return improving procurement efficiency over time.

### Working Example

An exemplary workflow provides a proper understanding of functioning of the present autonomous procurement assistant system and method. An example for “the procurement of laptop” using the present system is provided herein, the stepwise workflow includes the steps as given below:

### 1. User Interaction Through Computer-Based Application

The user logs into the procurement assistant system integrated within a computer-based application such as Teams,

User inputs the procurement requisition in the dialogue box “I want to purchase 5 laptops for the finance department.”

The natural language processing (NLP) engine interprets the request and identifies the relevant parameters such as

item type—laptops;

quantity—5;

department—finance.

The system sends a confirmation message of the requisition in the dialogue window “You have requested to procure 5 laptops for the finance department. Please confirm or refine your request.”

### 2. Policy Mapping and Agentic Orchestration

Once the user confirms the procurement request, the system automatically maps the user's request against the company's pre-defined procurement policies using the policy mapping unit:

Policy Rule 1: Laptops must be procured only from internal catalogues (No external purchases allowed).

Policy Rule 2: The budget cap is $10,000 (If the request exceeds, approval escalation is required).

Policy Rule 3: Third-party risk assessment is mandatory for all IT-related procurements.

Policy Rule 4: A formal contract must be signed before procurement approval.

The system then generates an agentic orchestration; whereby the system selects the necessary agents form an agentic library to create an automated workflow;

The agentic workflow is then visually displayed on collaboration dialogue window (13) outlining the proposed procurement steps:

“Step 1: Catalog Selection Agent—Fetches available laptop models from the internal catalog.” “Step 2: Supplier Selection Agent—Ensures procurement stays within the approved budget, lead time and compliance” “Step 3: Risk Assessment Agent—Evaluates supplier risk compliance.” “Step 4: Sourcing Agent (Optional)—Conducts auction-based sourcing if user opts in.”

“Step 5: Contract Creation & Signing Agent—Finalizes procurement agreements.”

The system displays an estimated timeline for procurement completion:

“Estimated Procurement Completion: 3 Days”

The user may customize the workflow by adding or removing any step:

“Please remove the risk assessment step”

The system validates the deviations of the configuration changes from the procurement policies of the company; and does not allow the mandatory agents to be removed at customization step; the dialogue window displays:

“Risk assessment is mandatory as per procurement policy. This agent cannot be removed.”

Where the user adds a step:

“Please add a negotiation step”

The system detects this and provides a timeline alert in the dialogue window:

“Adding a Negotiation Agent increases procurement time to 5 days. Your requested timeline is 3 days. Do you want to proceed?”

### 3. Agentic Orchestration Execution:

Once the user finalizes the agentic workflow by selecting “proceed” option, the orchestration engine of the processing automates the procurement process by triggering the various procurement agents involved in the workflow where:

The catalog selection agent retrieves and filters catalogues based on laptops, interacts with the user for laptop configuration finalization, and sends the selected laptop catalogue details to the supplier agent;

the supplier selection agent identifies suppliers as per the predefined user preferences including “model from internal catalog, with budget cap of $10,000 and procurement within 5 days”, the shortlisted laptop catalog is sent to sourcing agent;

The sourcing agent sends sourcing requests to shortlisted suppliers, collects and consolidates supplier bids, passes bid data to negotiation agent;

The negotiation agent analyses bid data and negotiates optimal pricing “less than $10,000” and terms “delivery in 5 days”, engages in autonomous communication with suppliers, sends final bid “delivery of 5 laptops within 5 days costing $10,000 for finance department” to contract creation agent;

The contract creation agent utilizes the data “delivery of 5 laptops within 5 days costing $10,000 for finance department” to auto-generate procurement contracts, incorporates negotiated terms and compliance requirements, and sends the final contract document to contract signing agent;

The contract signing agent facilitates contract approval by ensuring compliance with e-signature and legal validation, completing workflow by sending the final document to the user.

The system uses intelligent recommendations and adaptive learning from past events to refine future workflows providing real-time recommendations to the user, and provide real-time status updates on dialogue window of computer-based application allowing the users to track procurement progress.

While considerable emphasis has been placed herein on the specific elements of the preferred embodiment, it will be appreciated that many alterations can be made and that many modifications can be made in preferred embodiment without departing from the principles of the invention. These and other changes in the preferred embodiments of the invention will be apparent to those skilled in the art from the disclosure herein, whereby it is to be distinctly understood that the foregoing descriptive matter is to be interpreted merely as illustrative of the invention and not as a limitation.

What is claimed is:

1. An autonomous procurement assistant system using agentic orchestration and a procurement method thereof:
wherein the procurement assistant system comprises an input or output unit including a computer-based application with a collaboration dialogue window, a processing unit with a natural language processing engine (NLP), a policy mapping unit and an agentic orchestration engine displaying an agentic workflow, validating deviations from policies, and providing a plurality of procurement agents employing an agentic orchestration workflow run by the orchestration engine, characterized in that:
the autonomous procurement assistant system employs a method for procurement comprising the steps of:
user interaction through a computer-based application wherein;
a user logs into the procurement assistant system integrated within the computer-based application to initiate the procurement by providing an input of a procurement requisition in the form of free text in the dialogue window, such that the natural language processing (NLP) engine interprets the request provided by the user and identifies relevant parameters, followed by sending a confirmation message in the dialogue window wherein the user either confirms to proceed with the procurement; or chooses to refine details before proceeding;
policy mapping and agentic orchestration wherein:
the user confirms the procurement request allowing the system to automatically map the user's request against pre-defined procurement policies using the policy mapping unit;
generating an agentic orchestration; whereby the system selects the necessary agents from an agentic library to create an automated workflow where each agent performs a dedicated role to complete the procurement process;
displaying the agentic workflow on the collaboration dialogue window outlining the proposed procurement steps and the estimated timeline for procurement completion;
customizing configuration changes in the agentic workflow wherein the user can modify the workflow;
validating the deviations of the configuration changes from the procurement policies by the system where removing the mandatory agents is not allowed;
finalizing the agentic workflow by the user wherein the orchestration engine of the processing automates the procurement process by triggering the workflow;
agentic orchestration execution wherein:
the agentic orchestration engine provides the agentic orchestration workflow with a sequential step-by-step interaction of the plurality of procurement agents;
intelligent recommendations and adaptive learning wherein:
the system learns from past procurement events to refine future workflows thereby providing real-time recommendations for agent additions, removals, or sequence adjustments based on procurement trends and historical success rates thereby guiding the users in optimizing the procurement processes;
real-time status updates on dialogue window of computer-based application wherein:
the system provides status updates on the dialogue window as each agent completes its task allowing the users to track procurement progress without logging into different disparate systems.

2. The procurement assistant system as claimed in claim 1, wherein the natural language processing (NLP) engine interprets the user request and identifies the relevant parameters including item type, quantity, department, or any additional constraints.

3. The procurement assistant system as claimed in claim 1, wherein the agentic orchestration includes a structured sequence wherein each agent follows a sequence dynamically determined by the system, thereby performing a dedicated role to complete the procurement process.

4. The procurement assistant system as claimed in claim 1, wherein the customizing configuration changes allow the user to include additional agents or remove any agent based on any specific actions required to complete the process, and disallow the user to remove any mandatory agents required as per procurement policy.

5. The procurement assistant system as claimed in claim 1, wherein the procurement agents are selected from a catalog selection agent, supplier selection agent, sourcing agent, negotiation agent, contract creation agent, and contract signing agent, based on a query or procurement input provided by the user.

6. The procurement assistant system as claimed in claim 1, wherein the agentic orchestration workflow performed by the agentic orchestration engine comprises agents performing the steps of:
retrieving and filtering catalogues based on the user requirements, interacting with the user to finalize a workflow configuration and providing catalogue details by a catalog selection agent as an output to a supplier selection agent;
identifying the suppliers by adhering to pre-defined preferences thereby providing a list of shortlisted suppliers by the supplier selection agent as output for the sourcing agent;
sending sourcing requests to the shortlisted suppliers, collecting and consolidating the supplier bids by the sourcing agent, and passing the bid data to a negotiation agent;
analysing the bid data and negotiating pricing and terms by engaging in autonomous communication with the suppliers by the negotiation agent thereby sending the finalized bid details to a contract creation agent;
awarding data to auto-generate procurement contracts by incorporating negotiated terms and compliance requirements by the contract creation agent, further sending the contract details and documents to a contract signing agent;
facilitating the contract approval and signing digitally by the contract signing agent, thereby ensuring compliance with e-signature and legal validation and completing the procurement workflow, and presenting the approved document to the user using the dialogue window.

7. The procurement assistant system as claimed in claim 1, wherein the system provides a collaboration dialogue window allowing the users to interact with the system entirely without switching between multiple applications.

8. The procurement assistant system as claimed in claim 1, wherein the user provides input in a form of free text, thereby conversing with the system to provide a tangible output.

9. The procurement assistant system as claimed in claim 1, wherein the agentic orchestration using AI driven agents automate the procurement tasks while ensuring policy compliances, allowing users to customize and configure the procurement workflows within policy constraints, providing real-time alerts and checks timelines, thereby preventing inefficiencies, and adaptive intelligent learning from previous procurement workflows in return improving procurement efficiency over time.
